(19) United States
(12) Patent Application Publication
(10) Pub. No.: US 2026/0103060 A1
(43) Pub. Date: Apr. 16, 2026

(54) Vehicle Covering System

(71) Applicant: Hongbo WU, Ningbo (CN)

(72) Inventor: Hongbo WU, Ningbo (CN)

(21) Appl. No.: 18/911,396

(22) Filed: Oct. 10, 2024

(51) Int. Cl. B60J 7/14; B60J 10/90

(52) U.S. Cl. CPC B60J 7/141; B60J 10/90

(57) ABSTRACT

Provided herein is a vehicle covering system which includes a car body frame mechanism configured to be installed on a truck car body; a cover system, which is assembled on the car body frame mechanism and has at least an extended position and a stored position relative to the car body frame mechanism; a latch mechanism, which is configured on the cover frame mechanism, and the cover frame mechanism is releasably engaged with a second longitudinal frame through the latch mechanism, and the latch mechanism has at least an unlocked state and a locked state.

### TECHNICAL FIELD

The present disclosure relates generally to a vehicle covering system.

### BACKGROUND ART

Traditionally, pickup trucks are widely used vehicles that can transport cargo and passengers. Passengers are usually placed in the truck cab, while cargo can be stored in the truck bed. Truck beds are usually rectangular and open to the environment to facilitate loading and transporting large and/or oddly shaped cargo. However, exposing the truck bed to the environment may leave the truck bed and/or cargo unprotected. For example, the truck bed and/or cargo may be exposed to dust, precipitation (e.g., rain, snow, hail), etc. Therefore, some truck owners purchase truck covers to protect the truck bed and the items stored in the truck.

Existing truck cover systems have exposed some defects during use, such as: 1. Traditionally, cover systems are usually used to protect the cargo box of pickup trucks. Cover systems usually cover all or part of the cargo bed of the truck, thereby protecting any items stored and/or hauled in the cargo bed from external factors and theft. Many traditional cover systems releasably latch to the side rails of the truck at the tailgate to keep the cover closed. In order to facilitate access to the cargo bed, the latch structure of the cover system can be easily released. Specifically, the installation structure is relatively complicated, especially for the spring element. The lock tongue is generally assembled with two separate parts, namely the lock tongue body and the screw. The end of the screw is connected to the pull rope, the front end of the screw is threadedly connected to the lock tongue body, and a spring is mounted on the screw. Due to the large number of parts, the production and assembly are more complicated. In order to meet the use and installation of the spring on the screw, special structural processing is required for the end of the metal lock shell. The two sides of the end of the lock shell are bent inward and holes need to be formed, so the processing of the lock shell is more difficult. Since multiple parts work together, after long-term use, the structural accuracy of each component itself and the coordination accuracy between each other decrease, and it is more likely to become loose, resulting in unstable and inadequate operation of the locking mechanism. 2. The covering system adopts a single integral cover plate structure, which cannot realize the function of partial folding to open and close, and is relatively simple in usage; 3. The covering system adopts a multi-movable panel (cover plate) structure. The patent application number U.S. Ser. No. 18/172,891 shows that the two adjacent panels are connected by hinges, but due to the lack of a sealing structure at the hinge, rainwater will penetrate into the interior of the truck compartment through the gap between the hinge and the panel, the structural gap of the hinge itself, and other parts, causing the items stored in the truck compartment to be corroded by rainwater.

### SUMMARY

In order to overcome the above-mentioned deficiencies of the prior art, the present disclosure provides a vehicle covering system, which provides a more comprehensive sealing effect to prevent rainwater from penetrating into the interior of the truck compartment, thereby providing good protection for the stored items.

The technical solution of the present disclosure to solve the technical problem is: a vehicle coverage system, comprising:

A carriage frame mechanism is configured to be mounted on a truck carriage, wherein the carriage frame mechanism encloses a large open cavity;

A cover system is mounted on a carriage frame mechanism and is used to cover an open large cavity; the cover system comprises: one or more movable cover frame mechanisms, and a cover plate mounted in each cover frame mechanism, the cover frame mechanism divides the large cavity into one or more small cavities; the cover system has at least an unfolded position state and a stowed position state relative to the carriage frame mechanism;

A latch mechanism is arranged on the cover frame mechanism, and the cover frame mechanism is releasably engaged with the second longitudinal frame through the latch mechanism, and the latch mechanism has at least an unlocked state and a locked state; the latch mechanism comprises:
a latch base plate secured to the cover frame mechanism;
A first latch cover body is assembled on the latch bottom plate, and a latch cavity is formed between the first latch cover body and the latch bottom plate;
A lock tongue is movably disposed in the latch cavity, one end of the lock tongue is a locking end, and the other end is a transmission end, and the lock tongue has a lock tongue inner cavity, and the lock tongue inner cavity has an opening;
A pull cord connected to the transmission end of the lock body, the pull cord being controlled by the user;
The limiting part is located above the latch bottom plate, and the limiting part extends into the inner cavity of the lock tongue through the opening;
The spring is arranged in the inner cavity of the lock tongue, one end of the spring contacts the limiting part, and the other end contacts the inner wall of the inner cavity of the lock tongue.

The embodiment may also include one or more of the following features: when the latch mechanism is in an unlocked state, the cover frame mechanism can move relative to the carriage frame mechanism; when the latch mechanism is in a locked state, the cover frame mechanism is stationary relative to the carriage frame mechanism;

The user pulls the pull rope backward to control the lock tongue to move backward, and the latch mechanism switches to the unlocked state, so that the locking end and the second longitudinal frame are staggered in the vertical position, and the cover frame mechanism can move relative to the carriage frame mechanism;

When the user releases the pull cord, the spring acts on the lock tongue, causing the lock tongue to move forward so that the locking end overlaps with the second longitudinal frame in the vertical position, and the latch mechanism switches to the locked state, and the cover frame mechanism cannot move relative to the car frame mechanism.

According to some embodiments of the present disclosure, a connecting plate is attached to the carriage frame mechanism, the connecting plate is wrapped around the inner wall of the carriage frame mechanism, and the connecting plate is located between the carriage frame mechanism and the locking tongue.

The embodiment may also include one or more of the following features: the connecting plate includes a vertical portion, a first transverse portion bent outward from one end of the vertical portion, and a second transverse portion bent inward from the other end of the vertical portion;

The inner surface of the carriage frame mechanism has a first toothed side wall, and the outer surface of the vertical portion has a second toothed side wall, and the first toothed side wall and the second toothed side wall are meshed with each other so that the connecting plate is attached to the carriage frame mechanism.

The embodiment may further include one or more of the following features: the first transverse portion has a first accommodating groove, and the lower end of the first longitudinal frame is inserted into the first accommodating groove;

The second transverse portion has a second accommodating groove, and the inner side of the first longitudinal frame has a positioning block, which is inserted into the second accommodating groove.

Embodiments may further include one or more of the following features, wherein the vertical portion is fixed to the second longitudinal frame by a first fastener.

According to some embodiments of the present disclosure, the latch mechanism further includes:

A backing plate is arranged in the latch cavity, and the limiting portion is formed on the backing plate;
a second fastener that integrally connects the first latch cover, the backing plate, and the latch base;
A draw cord protection housing is attached to the draw cord.

According to some embodiments of the present disclosure, the latch mechanism further includes a second latch cover, one end of the second latch cover abuts against the first latch cover, and the other end of the second latch cover is fixed to the cover plate by a third fastener;

The second latch cover covers the connection between the transmission end and the pull rope;

The second latch cover body has a curved section, and the curved section gradually approaches the cover plate from a side close to the first latch cover body toward a side away from the first latch cover body.

According to some embodiments of the present disclosure, the vehicle covering system further includes a sealing mechanism, wherein the sealing mechanism includes:

A longitudinal sealing strip, the longitudinal sealing strip being mounted on the carriage frame mechanism, the longitudinal sealing strip having a first longitudinal side portion, the first longitudinal side portion being inclined downward from the inside to the outside;

A first transverse sealing strip, wherein there is a movable gap between adjacent cover plates, and the first transverse sealing strip is laid between adjacent cover plates so that the first transverse sealing strip blocks the movable gap;

The longitudinal sealing strip and the first transverse sealing strip are interlaced with each other and form an overlapping sealing area.

According to some embodiments of the present disclosure, the carriage frame mechanism includes:

A first transverse frame is disposed on the front edge of the freight car body;

A second transverse frame is disposed on the rear edge of the freight car body;

A first longitudinal frame is arranged on the left and right edges of the truck compartment, and the first longitudinal frame is located between the first transverse frame and the second transverse frame, and the longitudinal sealing strip is arranged on the first longitudinal frame;

The corner connecting member is fixed to the first transverse frame/the second transverse frame, and the corner connecting member rests on the first longitudinal frame.

According to some embodiments of the present disclosure, the capping frame mechanism comprises:

One or more third transverse frames are arranged between the left and right two first longitudinal frames;

A plurality of second longitudinal frames are arranged on the upper end of the first longitudinal frame, and the second longitudinal frames are spliced between two adjacent third transverse frames.

The embodiment may also include one or more of the following features: the third transverse frame and the second longitudinal frame both have a second mounting groove, and the edge of the cover plate is embedded in the second mounting groove, so that the cover plate is matched on the cover frame mechanism.

The embodiment may also include one or more of the following features: the longitudinal sealing strip is located between the first longitudinal frame and the second longitudinal frame, and the second longitudinal frame presses the longitudinal sealing strip against the second longitudinal frame under the action of gravity;

The movable gap is formed between two adjacent third transverse frames, and the first transverse sealing strip is assembled on the third transverse frame to seal the movable gap.

The embodiment may also include one or more of the following features: the lower end of the first transverse sealing strip has a strip-shaped mounting portion, the third transverse frame is provided with a first mounting groove, the strip-shaped mounting portion is inserted into the first mounting groove, so that the first transverse sealing strip is engaged with the third transverse frame;
longitudinal side edge of the first transverse sealing strip is bent downward to form a sealing crimping portion, and the sealing crimping portion is tightly fitted on the upper end surfaces of the third transverse frame and the second longitudinal frame.

The embodiment may further include one or more of the following features: the longitudinal sealing strip has a second longitudinal side portion, the second longitudinal side portion is inclined downward from the inside to the outside, and the second longitudinal side portion is located on the inner side of the first longitudinal side portion;
Under the action of gravity, the second longitudinal frame presses the second longitudinal side edge portion of the longitudinal sealing strip against the second longitudinal frame;
A raised portion is provided at the upper end of the first longitudinal frame, and the raised portion is tightly fitted with the longitudinal sealing strip.

According to some embodiments of the present disclosure, the sealing mechanism further comprises a supplementary sealing strip, a frame gap is formed between two adjacent second longitudinal frames, and the supplementary sealing strip is inserted into the frame gap;
longitudinal side edges of the supplementary sealing strip are in contact with the two second longitudinal frames respectively, the upper end surface of the supplementary sealing strip is in contact with the first transverse sealing strip, and the lower end surface of the supplementary sealing strip is in contact with the first longitudinal frame.

According to some embodiments of the present disclosure, the sealing mechanism further comprises:
A second transverse sealing strip is arranged below the first transverse frame, the second transverse sealing strip comprises a first straight sealing portion, a circular sealing portion and a first transverse side portion, the upper end surface of the first straight sealing portion contacts the first transverse frame, the lower end of the circular sealing portion contacts the truck compartment, and the first transverse side portion is inclined downward from the rear to the front;
The third transverse sealing strip is arranged below the second transverse frame. The third transverse sealing strip includes a second straight sealing portion, a second transverse side portion and a third transverse side portion. The upper end surface of the second straight sealing portion contacts the second transverse frame, the lower ends of the second transverse side portion and the third transverse side portion contact the truck compartment, the second transverse side portion and the third transverse side portion are inclined downward from back to front, the size of the third transverse side portion is larger than the size of the second transverse side portion, and the third transverse side portion is located in front of the second transverse side portion.

The embodiment may also include one or more of the following features: the second longitudinal frame has a positioning groove at one end close to the third transverse frame, and the end of the third transverse frame is inserted into the positioning groove, so that the third transverse frame and the second longitudinal frame are enclosed and combined to form the small cavity.

According to some embodiments of the present disclosure, the vehicle covering system further comprises a supporting mechanism, which can act on the covering system so that the covering system has a standing position relative to the vehicle frame mechanism;

The supporting mechanism includes:
A first base is arranged on the carriage frame mechanism;
A second base is configured on any one or more cover plates;
A support rod having a first end and a second end, wherein the first end is hinged to the first base and the second end is detachably connected to the second base;
The hook is arranged on the carriage frame mechanism and has a hanging groove, and the support rod can be inserted into the hanging groove or detached from the hanging groove.

The embodiment may also include one or more of the following features: the first end and the second end both have a spherical groove, the first base and the second base both have a ball head end, and the ball head end can be inserted into the spherical groove or detached from the spherical groove.

The beneficial effects of the present disclosure are:
A latch mechanism is provided for locking or releasing the cover frame mechanism, so that the cover system can be switched between the deployed position, the stowed position and the standing position relative to the carriage frame mechanism.

The integrated lock tongue is adopted, with the structure and function integrated into one, replacing the existing lock tongue body and screw combination scheme, the spring is directly installed in the lock tongue cavity, and the bending structure at the end of the lock shell is eliminated. Therefore, the number of parts is reduced, the production and assembly are simpler and more practical, and it is more stable and reliable after long-term use.

The longitudinal sealing strip of the present application is used to provide good longitudinal waterproof and sealing functions between the carriage frame mechanism and the truck carriage; the first transverse sealing strip of the present application is used, and the first transverse sealing strip is laid between adjacent cover plates, so that the first transverse sealing strip blocks the movable gap, and provides good transverse waterproof and sealing functions between adjacent cover frame mechanisms. On the other hand, the longitudinal sealing strip and the first transverse sealing strip are interlaced with each other and form an overlapping sealing area, eliminating the gap that may exist between the longitudinal sealing strip and the first transverse sealing strip, and improving the sealing effect between the two.

The cooperation between the first transverse sealing strip and the two adjacent second longitudinal frames not only plays a sealing role, but also forms a structure similar to a hinge, so that the adjacent cover frame mechanisms can be turned over and moved.

A frame gap is formed between the cover frames to eliminate the structural interference between two adjacent cover frame mechanisms and provide sufficient space for movement. A supplementary sealing strip is arranged at the frame gap to prevent rainwater from seeping in from the frame gap.

It has a second transverse sealing strip to effectively prevent rainwater from entering the interior of the truck compartment from the position between the first transverse frame and the truck compartment; it has a third transverse sealing strip to effectively prevent rainwater from entering the interior of the truck compartment from the position between the second transverse frame and the truck compartment.

A supporting mechanism is provided, which can act on the covering system so that the covering system can be continuously and stably in a standing position relative to the carriage frame mechanism.

### BRIEF DESCRIPTION OF THE DRAWINGS

FIG. 1 is a schematic diagram of a truck having a truck covering system according to various embodiments.

FIG. 2 is a schematic structural diagram from an upper perspective of a cover system in an expanded position according to some embodiments of the present disclosure.

FIG. 3 is a schematic structural diagram of a cover system in some embodiments of the present disclosure in an expanded position from a bottom perspective.

FIG. 4 is a side schematic diagram of a cover system in a storage position according to some embodiments of the present disclosure.

FIG. 5 is a side schematic diagram of the cover system in a standing position according to some embodiments of the present disclosure.

FIG. 6 is an exploded view of a vehicle covering system according to some embodiments of the present disclosure.

FIG. 7 is an enlarged transverse cross-sectional view of a local structure at a longitudinal base frame in some embodiments of the present disclosure.

FIG. 8 is an exploded and enlarged view of a local structure in some embodiments of the present disclosure.

FIG. 9 is an enlarged longitudinal cross-sectional view of the local structure at the intersection of the longitudinal sealing strip and the first transverse sealing strip according to some embodiments of the present disclosure.

FIG. 10 is an enlarged longitudinal cross-sectional view of a partial structure of a cover frame mechanism and a first transverse sealing strip according to some embodiments of the present disclosure.

FIG. 11 is an enlarged longitudinal cross-sectional view of a local structure at a second transverse sealing strip according to some embodiments of the present disclosure.

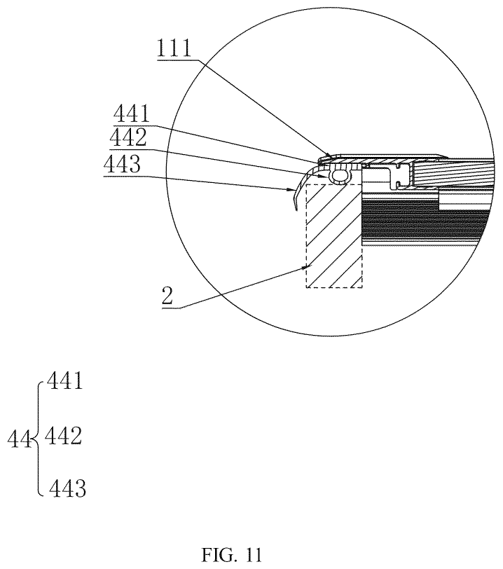

FIG. 12 is an enlarged longitudinal cross-sectional view of a local structure at a third transverse sealing strip in some embodiments of the present disclosure.

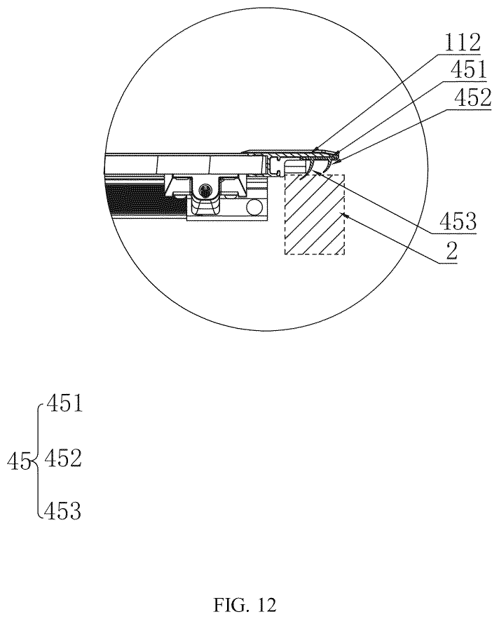

FIG. 13 is an exploded enlarged view of a latch mechanism according to some embodiments of the present disclosure.

FIG. 14 is an enlarged cross-sectional view of a partial structure of the latch mechanism in a locked state according to some embodiments of the present disclosure.

FIG. 15 is an enlarged cross-sectional view of a partial structure of a latch mechanism in an unlocked state according to some embodiments of the present disclosure.

FIG. 16 is a partial schematic diagram of a connecting plate and a first longitudinal frame according to some embodiments of the present disclosure.

FIG. 17 is a partial schematic diagram of a support structure according to some embodiments of the present disclosure.

FIG. 18 is an exploded view of a support structure according to some embodiments of the present disclosure.

FIG. 19 is a structural side view of a longitudinal sealing strip.

FIG. 20 is a structural side view of the first transverse sealing strip.

FIG. 21 is a structural side view of the second transverse sealing strip.

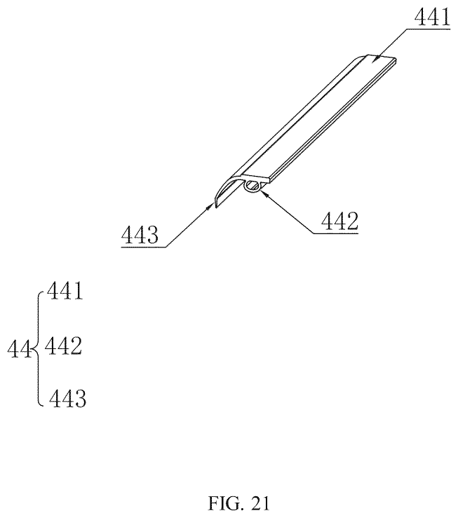

FIG. 22 is a structural side view of the third transverse sealing strip.

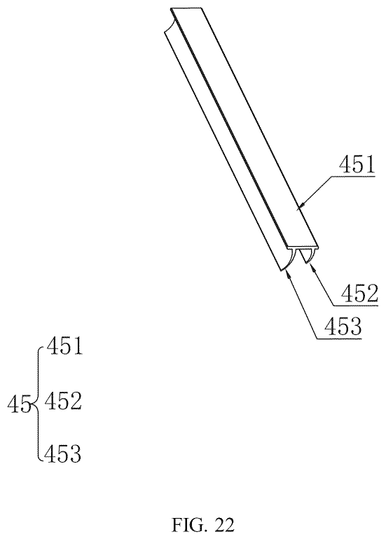

In the figure:
1. vehicle covering system; 11. carriage frame mechanism; 11a. open large cavity; 111. first transverse frame; 112. second transverse frame; 113. first longitudinal frame; 113a. first toothed side wall; 113b. raised portion; 113c. lower end of first longitudinal frame; 113d. positioning block; 114. corner connecting member; 2. truck carriage; 3. cover system; 3a. unfolded position; 3b. stowed position; 3c. standing position; 31. cover frame mechanism; 311. third transverse frame; 311a. end of the third transverse frame; 311b. first mounting groove; 312. second longitudinal frame; 312a. positioning groove; 312c. frame gap; 32. cover plate; 32b. small cavity; 321. movable gap; 33. second mounting groove; 4. sealing mechanism; 41. longitudinal sealing strip; 411. first longitudinal side portion; 412. second longitudinal side portion; 413. overlapping sealing area; 42. first transverse sealing strip; 421. strip-shaped mounting portion; 422. sealing Crimping portion; 43, supplementary sealing strip; 44, second transverse sealing strip; 441, first straight sealing portion; 442, circular sealing portion; 443, first transverse side portion; 45, third transverse sealing strip; 451, second straight sealing portion; 452, second transverse side portion; 453, third transverse side portion; 5, latch mechanism; 5a, unlocked state; 5b, locked state; 51, latch base plate; 52, first latch cover; 53, latch cavity; 54, lock tongue; 54a, locking end; 54b, transmission end; 541, inner cavity of the lock tongue; 541a, opening; 541b, front wall of the inner cavity of the lock tongue; 55, pull rope; 56, limiting part; 57, spring; 58, pad; 581, second fastener; 582, pull rope protection shell; 59, second latch cover; 591, third fastener; 59a, curved section; 6, connecting plate; 61, vertical part; 611, second toothed side wall; 62, first transverse part; 621, first accommodating groove; 63, second transverse part; 631, second accommodating groove; 64, first fastener; 7, supporting mechanism; 71, first base; 72, second base; 73, supporting rod; 731, first end; 732, second end; 73a, spherical groove; 73b, ball head end; 74, hook; 74a, hanging groove.

### DETAILED DESCRIPTION

The following will be combined with the drawings in the embodiments of the present disclosure to clearly and completely describe the technical solutions in the embodiments of the present disclosure. Obviously, the described embodiments are only part of the embodiments of the present disclosure, not all of the embodiments. Based on the embodiments of the present disclosure, all other embodiments obtained by ordinary technicians in this field without creative work are within the scope of protection of the present disclosure.

### Embodiment 1

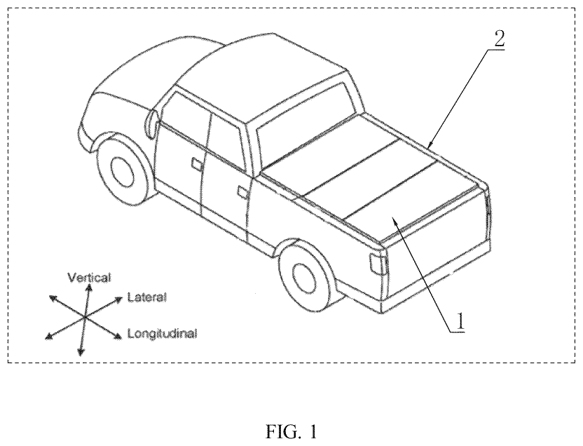

Referring to FIG. 1, a vehicle covering system 1 is characterized by comprising:

The carriage frame mechanism 11 is configured to be mounted on the truck carriage 2, and the carriage frame mechanism 11 encloses an open large cavity 11a. In a specific embodiment, the carriage frame mechanism 11 is rectangular, matching the shape of most truck carriages 2 on the market.

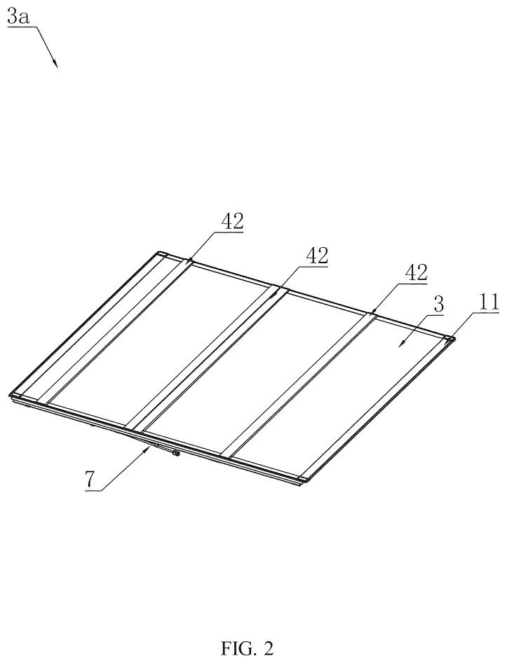

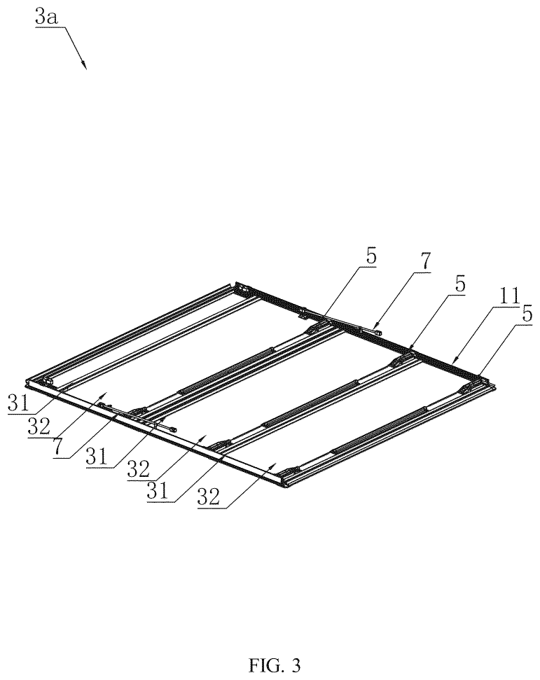

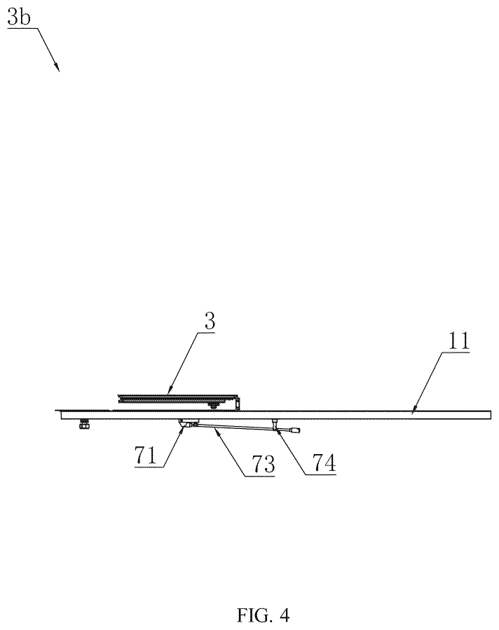

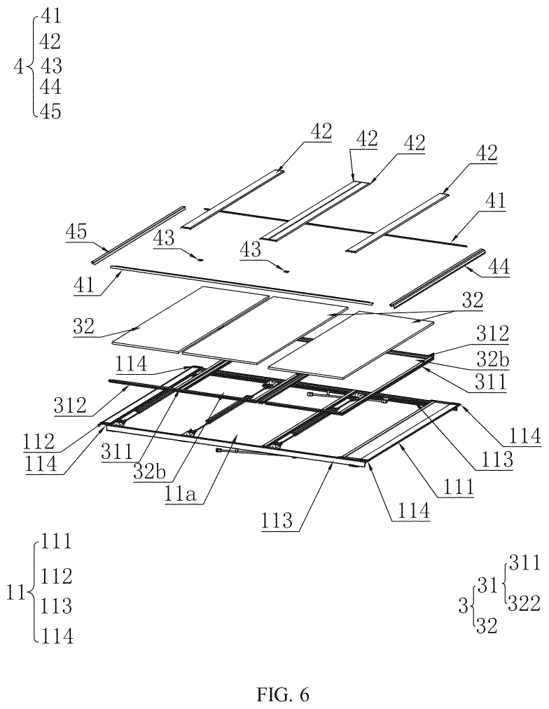

The cover system 3 is mounted on the carriage frame mechanism 11 and is used to cover the open large cavity 11a, thereby isolating the truck carriage 2 from the outside and providing protection for the items stored in the truck carriage 2. Specifically, referring to FIG. 6, the cover system 3 includes: one or more movable cover frame mechanisms 31, and a cover plate 32 mounted in each cover frame mechanism 31. The cover frame mechanism 31 divides the large cavity into one or more small cavities 32b, and the cover plate 32 is mounted in each small cavity 32b. When each small cavity 32b is equipped with a cover plate 32, the large cavity is completely covered by the multiple cover plates 32. Since the cover frame mechanism 31 is movable, the cover system 3 has at least an unfolded position state 3a and a stored position state 3b relative to the carriage frame mechanism 11. Specifically, referring to FIGS. 2 and 3, when the covering system 3 is in the expanded position state 3a, each covering frame mechanism 31 (cover plate 32) is laid flat on the car frame mechanism 11 (truck car 2) to close the large cavity; referring to FIG. 4, when the covering system 3 is in the stored position state 3b, part or all of the covering frame mechanisms 31 (cover plates 32) are detached from the car frame mechanism 11 (truck car 2) to release the large cavity partially or as a whole.

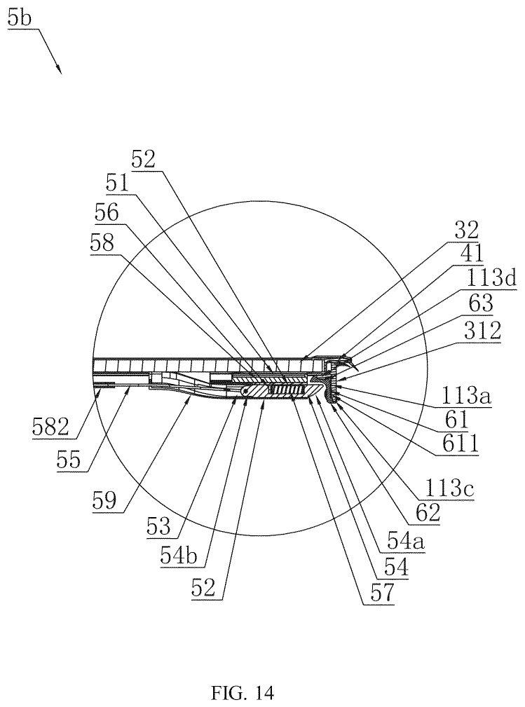

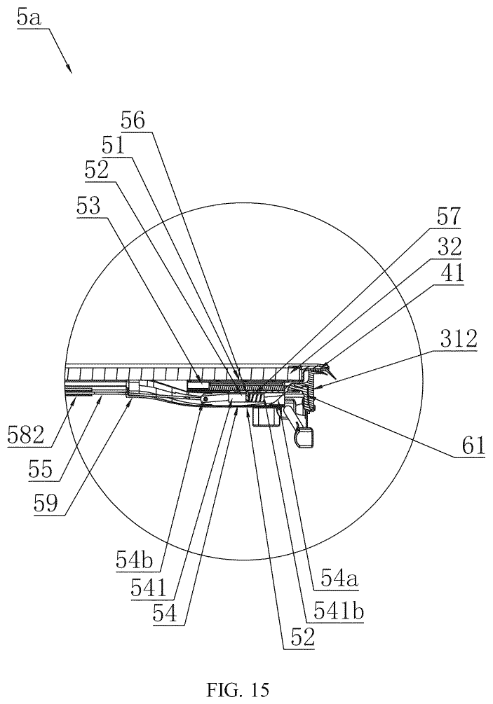

The latch mechanism 5 is arranged on the cover frame mechanism 31, and the cover frame mechanism 31 is releasably engaged with the second longitudinal frame 312 through the latch mechanism 5, and the latch mechanism 5 has at least an unlocked state 5a and a locked state 5b; referring to FIG. 15, when the latch mechanism 5 is in the unlocked state 5a, the cover frame mechanism 31 can move relative to the car frame mechanism 11; referring to FIG. 14, when the latch mechanism 5 is in the locked state 5b, the cover frame mechanism 31 is stationary relative to the car frame mechanism 11.

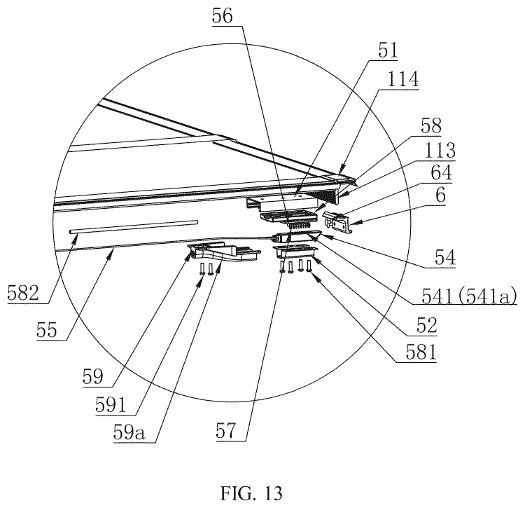

According to some embodiments of the present disclosure, the figure is only an example, which should not unduly limit the scope of the claims. Those skilled in the art will recognize many variations, substitutions and modifications. Referring to FIGS. 13 to 15, the latch mechanism 5 includes: a latch base plate 51, fixed to the cover frame mechanism 31; a first latch cover body 52, assembled on the latch base plate 51, and a latch cavity 53 is formed between the first latch cover body 52 and the latch base plate 51; a lock tongue 54, movably configured in the latch cavity 53, one end of the lock tongue 54 is a locking end 54a, and the other end is a transmission end 54b, and the lock tongue 54 has an inner cavity of the lock tongue 54. The inner cavity of the lock tongue 54 has an opening 541a, and the opening 541a is set downward; the pull rope 55 is connected to the transmission end 54b of the lock body, and the pull rope 55 is controlled by the user; the limiting portion 56 is located above the latch base plate 51, and the limiting portion 56 extends into the inner cavity of the lock tongue 54 through the opening 541a; the spring 57 is arranged in the inner cavity of the lock tongue 54, one end of the spring 57 contacts the limiting portion 56, and the other end contacts the inner wall of the inner cavity of the lock tongue 54. The working principle of the latch mechanism 5 of the above structure is: the user pulls the pull rope 55 backward to control the locking tongue 54 to move backward (at most to the point where the front wall of the inner cavity of the locking tongue 54 abuts against the limiting portion 56), so that the locking end 54a and the second longitudinal frame 312 are staggered in the vertical position, and the covering frame mechanism 31 can move relative to the car frame mechanism 11; the user releases the pull rope 55, and the spring 57 acts on the locking tongue 54, so that the locking tongue 54 moves forward, so that the locking end 54a and the second longitudinal frame 312 overlap in the vertical position, and the covering frame mechanism 31 cannot move relative to the car frame mechanism 11.

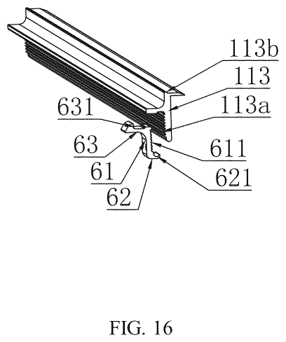

Referring to FIGS. 13 to 16, in some optional embodiments, a connecting plate 6 is attached to the carriage frame mechanism 11, and the connecting plate 6 is covered on the inner wall of the carriage frame mechanism 11, and the connecting plate 6 is located between the carriage frame mechanism 11 and the lock tongue 54. During operation, the latch mechanism 5 can indirectly lock the carriage frame mechanism 11 through the connecting plate 6, and the latch mechanism 5 will not directly contact the carriage frame mechanism 11, thereby reducing the probability of damage to the latch mechanism 5 and the carriage frame mechanism 11, and playing an effective physical protection role. On the other hand, as an independently formed component, the connecting plate 6 has stronger plasticity and can be structurally changed and produced and assembled according to the shape of different vehicle covering systems 1 to meet the needs of various trucks; on the other hand, in order for the lock tongue 54 to move forward or backward smoothly, there must be a certain movement space between the lock tongue 54 and the carriage frame mechanism 11. If the movement space is too large, the cover system 3 (latch mechanism 5) will vibrate over a large distance relative to the carriage frame mechanism 11 during the vehicle driving, which is easy to cause the cover system 3 to be damaged. Therefore, the existence of the connecting plate 6 can fill the movement space to a certain extent, thereby reducing the vibration amplitude and effectively protecting the capping system 3.

In some optional embodiments, a structural scheme of the connecting plate 6 is provided, specifically: with reference to FIGS. 13 to 16, the connecting plate 6 includes a vertical portion 61, a first transverse portion 62 bent outward from one end of the vertical portion 61, and a second transverse portion 63 bent inward from the other end of the vertical portion 61. The inner surface of the carriage frame mechanism 11 has a first toothed side wall 113a, and the outer surface of the vertical portion 61 has a second toothed side wall 611, and the first toothed side wall 113a and the second toothed side wall 611 are meshed with each other, so that the connecting plate 6 is attached to the carriage frame mechanism 11. The first transverse portion 62 has a first accommodating groove 621, and the lower end of the first longitudinal frame 113 is inserted into the first accommodating groove 621; the second transverse portion 63 has a second accommodating groove 631, and the inner side of the first longitudinal frame 113 has a positioning block 113d, and the positioning block 113d is inserted into the second accommodating groove 631. By adopting the structural scheme of the connecting plate 6, the connecting plate 6 is more stably connected to the car frame mechanism 11, and the connecting plate 6 can wrap the edge of the car frame mechanism 11, thereby preventing the sharp edge of the metal car frame mechanism 11 from directly contacting the user's body or the cover system 3 (cover plate 32) and causing damage.

As for a more reliable fixing method of the connecting plate 6, on the original basis, the vertical portion 61 is also fixed to the second longitudinal frame 312 by a first fastener 64.

The embodiment may also include one or more of the following features. Referring to FIG. 13, the latch mechanism 5 further includes: a backing plate 58, which is disposed in the latch cavity 53, and the stopper 56 is formed on the backing plate 58; a second fastener 581, which connects the first latch cover 52, the backing plate 58 and the latch bottom plate 51 together; and a pull cord 55 protection housing, which is attached to the pull cord 55. On the one hand, the backing plate 58 can play a role in adjusting the size of the internal space of the latch cavity 53, so that the lock tongue 54 can be raised or lowered and adjusted to the best use position; on the other hand, the backing plate 58 is used as a structural transition component, and the connection between the first latch cover 52 and the latch bottom plate 51 is more stable through the second fastener 581.

In some optional embodiments, referring to FIGS. 13 to 15, the latch mechanism 5 further includes a second latch cover 59, one end of which abuts against the first latch cover 52, and the other end of which is fixed to the cover plate 32 by a third fastener 591; the second latch cover 59 covers the connection between the transmission end 54b and the pull rope 55; the second latch cover 59 has a curved section 59a, which gradually approaches the cover plate 32 from the side close to the first latch cover 52 to the side away from the first latch cover 52. On the one hand, the second latch cover 59 can be considered as an extension structure of the first latch cover 52 in some cases, thereby effectively protecting other components (such as the pull rope 55, the lock tongue 54, etc.) covered therein. On the other hand, the existence of the connecting plate 6 makes the matching size of the third fastener 591 larger, so that the third fastener 591 plays a more reliable fastening function. Thirdly, since the components themselves have a certain size, there must be a certain height difference between the lock tongue 54 and the cover plate 32, which indirectly causes the pull rope 55 to be tilted in the height direction, especially at the connection between the lock tongue 54 and the pull rope 55 (close to the transmission end 54b of the lock tongue 54). The strength of the pull rope 55 in an uneven state will be greatly weakened. By setting the curved section 59a, it can adapt to the shape of the pull rope 55 near the transmission end 54b of the lock tongue 54, thereby achieving better shielding and protection effects on the pull rope 55.

### Embodiment 2

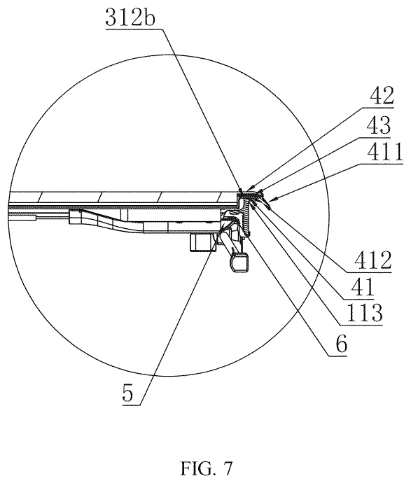

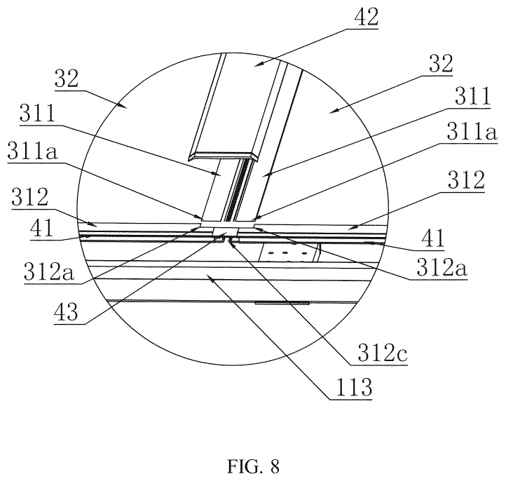

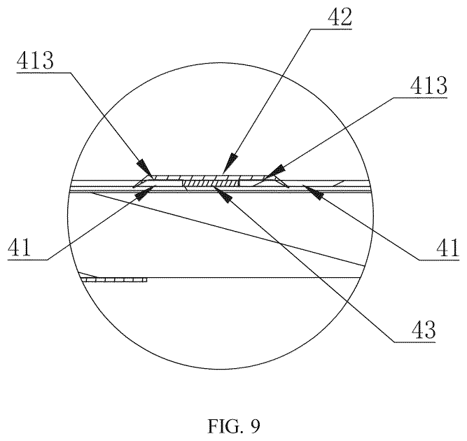

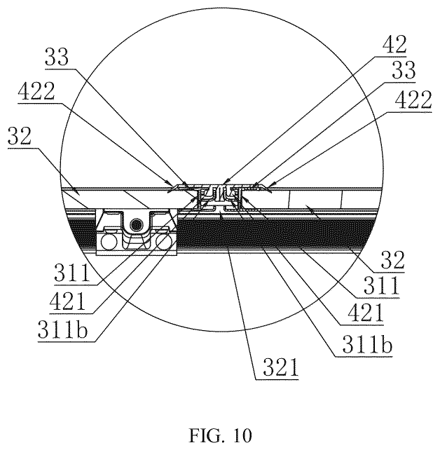

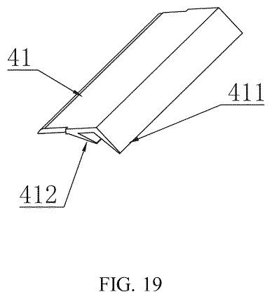

In a specific embodiment, the vehicle covering system 1 includes a sealing mechanism 4. Specifically, referring to FIGS. 2 and 6, the sealing mechanism 4 includes a longitudinal sealing strip 41 and a first transverse sealing strip 42. The configuration position of the longitudinal sealing strip 41 is similar to that in a conventional trunk lid system, specifically, the longitudinal sealing strip 41 is assembled on the vehicle frame mechanism 11. Referring to FIGS. 7 and 19, the longitudinal sealing strip 41 of this structure has a first longitudinal side portion 411, and the first longitudinal side portion 411 is inclined downward from the inside to the outside. When rainwater falls on the first longitudinal side portion 411, it can be discharged outward and downward to the outside of the vehicle covering system 1 under the guidance of the first longitudinal side portion 411, effectively preventing rainwater from entering the interior of the truck compartment 2 from between the longitudinal side of the compartment frame mechanism 11 and the truck compartment 2. On the other hand, referring to FIG. 8, FIG. 9 and FIG. 10, there is a movable gap 321 between adjacent cover plates 32 (cover frame mechanism 31), and rainwater will generally enter the interior of the truck compartment 2 along the movable gap 321, thereby eroding the items stored in the truck compartment 2. In order to ensure the waterproof performance of the interior of the truck compartment 2, the first transverse sealing strip 42 in the sealing mechanism 4 is laid between adjacent cover plates 32, so that the first transverse sealing strip 42 blocks the movable gap 321. On the other hand, referring to FIG. 9, the longitudinal sealing strip 41 and the first transverse sealing strip 42 are interlaced with each other and form an overlapping sealing area 413, eliminating the gap that may exist between the longitudinal sealing strip 41 and the first transverse sealing strip 42, and improving the sealing effect between the two.

The embodiment may also include one or more of the following features. Referring to FIGS. 2, 3, and 6, the car frame mechanism 11 includes: a first transverse frame 111, which is arranged on the front edge of the truck car 2; a second transverse frame 112, which is arranged on the rear edge of the truck car 2; a first longitudinal frame 113, which is arranged on the left and right edges of the truck car 2, and the first longitudinal frame 113 is located between the first transverse frame 111 and the second transverse frame 112, and the longitudinal sealing strip 41 is arranged on the first longitudinal frame 113; a corner connecting member 114, which is fixed to the first transverse frame 111/the second transverse frame 112, and the corner connecting member 114 is placed on the first longitudinal frame 113 to form an integral car frame mechanism 11. If the corner connecting member 114 is removed, the connection between the first longitudinal frame 113 and the first transverse frame 111/the second transverse frame 112 can be released, and then each frame can be disassembled.

The embodiment may also include one or more of the following features. Referring to FIG. 6, the capping frame mechanism 31 includes: one or more third transverse frames 311, which are arranged between the left and right two first longitudinal frames 113; a plurality of second longitudinal frames 312, which are arranged at the upper end of the first longitudinal frame 113, and the second longitudinal frames 312 are spliced between two adjacent third transverse frames 311, so as to combine a complete capping frame mechanism 31. The number of the capping frame mechanisms 31 can be one or more, and the corresponding number of third transverse frames 311 and second longitudinal frames 312 are selected according to the number of the capping frame mechanisms 31.

According to the above embodiment, the matching structure of the cover plate 32 and the car frame mechanism 11 can be: referring to FIG. 10, the third transverse frame 311 and the second longitudinal frame 312 both have a second mounting groove 33, and the edge of the cover plate 32 is embedded in the second mounting groove 33, so that the cover plate 32 is matched on the covering frame mechanism 31.

In some optional structural embodiments, referring to FIG. 8, the second longitudinal frame 312 has a positioning groove 312a at one end close to the third transverse frame 311, and the end of the third transverse frame 311 is inserted into the positioning groove 312a, which has a quick positioning effect, so that the third transverse frame 311 and the second longitudinal frame 312 are enclosed and combined to form the small cavity 32b.

The arrangement of the longitudinal sealing strip 41 is further described. Referring to FIG. 7 and FIG. 19, the longitudinal sealing strip 41 is located between the first longitudinal frame 113 and the second longitudinal frame 312. Under the action of gravity, the second longitudinal frame 312 presses the longitudinal sealing strip 41 and forces the longitudinal sealing strip 41 to press against the second longitudinal frame 312. More specifically, the longitudinal sealing strip 41 has a second longitudinal side portion 412, which is inclined downward from the inside to the outside, and is located on the inner side of the first longitudinal side portion 411; under the action of gravity, the second longitudinal frame 312 presses the second longitudinal side portion 412 of the longitudinal sealing strip 41 against the second longitudinal frame 312, and when rainwater falls on the second longitudinal side portion 412, it can be guided by the second longitudinal side portion 412 and discharged outward and downward to the outside of the vehicle covering system 1. The first longitudinal side portion 411 and the second longitudinal side portion 412 cooperate with each other, can be deformed when subjected to force and always in contact with the second longitudinal frame 312, thereby playing a dual water-conducting function; a raised portion 113b is provided at the upper end of the first longitudinal frame 113, and the raised portion 113b is tightly fitted with the longitudinal sealing strip 41.

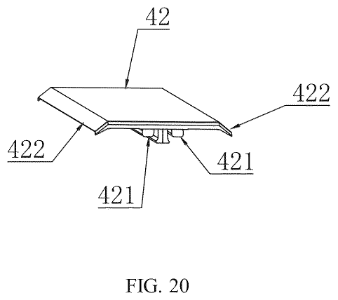

The arrangement of the first transverse sealing strip 42 is further described. The movable gap 321 is formed between two adjacent third transverse frames 311. The first transverse sealing strip 42 is assembled on the third transverse frame 311 and blocks the movable gap 321. More specifically, referring to FIGS. 8, 9, 10, and 20, the lower end of the first transverse sealing strip 42 has a strip-shaped mounting portion 421. The third transverse frame 311 is provided with a first mounting groove 311b. The strip-shaped mounting portion 421 is inserted into the first mounting groove 311b, so that the first transverse sealing strip 42 is engaged with the third transverse frame 311. The longitudinal side edge of the first transverse sealing strip 42 is bent downward to form a sealing crimping portion 422. The sealing crimping portion 422 is tightly fitted on the upper end surfaces of the third transverse frame 311 and the second longitudinal frame 312.

It should be noted that, referring to FIG. 10, the cooperation between the first transverse sealing strip 42 and the two adjacent second longitudinal frames 312 not only plays a sealing role, but also forms a structure similar to a hinge, so that the adjacent cover frame mechanisms 31 can be turned over and moved.

The embodiment may also include one or more of the following features. A frame gap 312c is formed between two adjacent second longitudinal frames 312. The existence of the frame gap 312c is to eliminate the structural interference between the two adjacent cover frame mechanisms 31 and provide sufficient space for movement. Referring to FIGS. 7, 8, and 9, in order to prevent rainwater from seeping from the frame gap 312c, the sealing mechanism 4 also includes a supplementary sealing strip 43, and the supplementary sealing strip 43 is inserted into the frame gap 312c. A more complete structural description of the supplementary sealing strip 43 is as follows: the longitudinal side edges of the supplementary sealing strip 43 are in contact with the two second longitudinal frames 312 respectively, the upper end face of the supplementary sealing strip 43 is in contact with the first transverse sealing strip 42, and the lower end face of the supplementary sealing strip 43 is in contact with the first longitudinal frame 113.

In some optional structural embodiments, the sealing mechanism 4 in the present disclosure is made of flexible materials, such as rubber and other materials; the carriage frame mechanism 11 is made of hard materials, such as metal materials such as aluminum alloy; the cover plate 32 can be made of flexible materials, such as artificial leather and other materials, or can be made of hard materials, such as hard plastic or aluminum alloy and other materials.

In some optional embodiments, the sealing mechanism 4 further includes:

11 and 21, the second transverse sealing strip 44 is arranged below the first transverse frame 111, and the second transverse sealing strip 44 comprises a first straight sealing portion 441, a circular sealing portion 442 and a first transverse side portion 443. The upper end surface of the first straight sealing portion 441 is always in contact with the first transverse frame 111 to play a local sealing role; the circular sealing portion 442 can be adaptively deformed under pressure, so that the lower end of the circular sealing portion 442 is always in contact with and sealed with the truck compartment 2; the first transverse side portion 443 is inclined downward from the back to the front, and when rainwater falls on the first transverse side portion 443, it can be guided by the first transverse side portion 443 and discharged outward and downward to the outside of the vehicle covering system 1, effectively preventing rainwater from entering the interior of the truck compartment 2 from the position between the first transverse frame 111 and the truck compartment 2.

12 and 22, the third transverse sealing strip 45 is disposed below the second transverse frame 112, and the third transverse sealing strip 45 includes a second straight sealing portion 451, a second transverse side portion 452 and a third transverse side portion 453. The upper end surface of the second straight sealing portion 451 always keeps in contact with the second transverse frame 112 to play a local sealing role; the lower ends of the second transverse side portion 452 and the third transverse side portion 453 are in contact with the truck compartment 2, and the second transverse side portion 452 and the third transverse side portion 453 are inclined downward from back to front. The size of the third transverse side portion 453 is larger than that of the second transverse side portion 452, and the third transverse side portion 453 is located in front of the second transverse side portion 452. Under this structure, the water-retaining ability of the third transverse side portion 453 is stronger than that of the second transverse side portion 452. Therefore, even if the sealing performance of the second transverse side portion 452 is insufficient when encountering heavy rain, the sealing performance of the third transverse side portion 453 can still achieve a good water-retaining effect. When rainwater falls on the second transverse side portion 452 or the third transverse side portion 453, it can be discharged outward and downward to the outside of the vehicle covering system 1 under the guidance of the second transverse side portion 452 or the third transverse side portion 453, effectively preventing rainwater from entering the interior of the truck compartment 2 from the position between the second transverse frame 112 and the truck compartment 2. At the same time, the second transverse side portion 452 and the third transverse side portion 453 form two rainwater blocking lines to achieve double waterproof and sealing effects.

### Embodiment 3

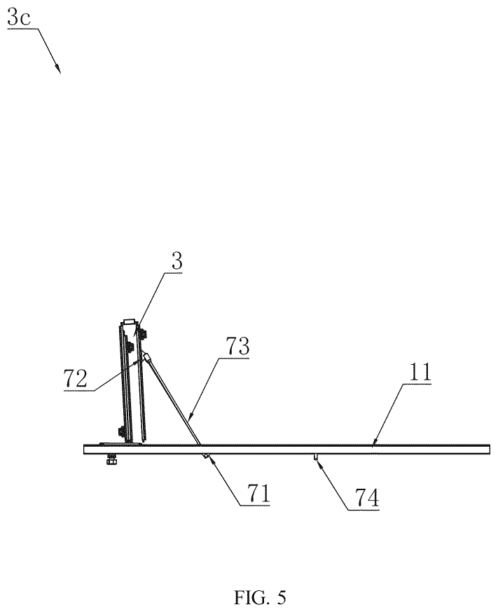

In a specific embodiment, referring to FIGS. 3, 4 and 5, the vehicle covering system 1 includes a supporting mechanism 7, which can act on the covering system 3 so that the covering system 3 has a standing position state 3c relative to the vehicle frame mechanism 11. The standing position state 3c is a state between the unfolded position state 3a and the stored position state 3b. In most scenarios, the standing position state 3c corresponds to a portion of the cover plate 32 being laid flat, and the other portion of the cover plate 32 being flipped and standing and being in an approximately vertical position relationship with the laid flat cover plate 32.

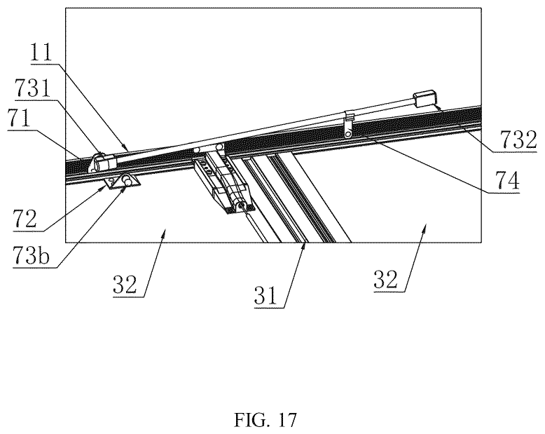

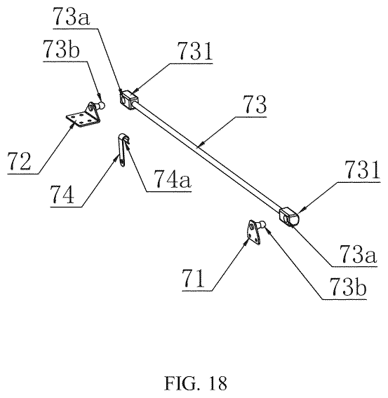

The support mechanism 7 is further described as follows. Referring to FIGS. 17 and 18, the support mechanism 7 includes: a first base 71 disposed on the carriage frame mechanism 11; a second base 72 disposed on any one or more cover plates 32; and a support rod 73 having a first end 731 and a second end 732. Among them, the first end 731 is hinged to the first base 71, and the support rod 73 can rotate relative to the first base 71; the second end 732 is detachably connected to the second base 72. When the second end 732 is connected to the second base 72, the support rod 73 is respectively connected to the first base 71 and the second base 72. At this stage, the lower support rod 73 supports the cover plate 32. Through the work of the support rod 73, part of the cover plate 32 is continuously in a standing posture relative to the car frame mechanism 11, and the corresponding covering system 3 is in a standing position state 3c; when the second end 732 is separated from the second base 72, at this stage, the lower support rod 73 does not support the cover plate 32. Therefore, when the function of the support rod 73 is lost, the cover plate 32 cannot continue to be in a standing posture relative to the car frame mechanism 11, and the covering system 3 cannot stably maintain the standing position state 3c. The hook 74 is arranged on the carriage frame mechanism 11, and has a hanging groove 74a, and the support rod 73 can be inserted into the hanging groove 74a or detached from the hanging groove 74a. When the cover system 3 is in the unfolded position state 3a or the stored position state 3b, the support rod 73 is inserted into the hanging groove 74a to store the support rod 73 and prevent the support rod 73 from being damaged due to disorderly movement; when the cover system 3 needs to be switched to the standing position state 3c, the support rod 73 is detached from the hanging groove 74a in advance to facilitate the movement and position adjustment of the support rod 73.

According to some embodiments of the present disclosure, referring to FIG. 18, the first end 731 and the second end 732 both have a spherical groove 73a, and the first base 71 and the second base 72 both have a ball head end 73b, and the ball head end 73b can be inserted into the spherical groove 73a or detached from the spherical groove 73a. The cooperation between the ball head end 73b and the spherical groove 73a can realize the connection function on the one hand, and on the other hand, can make the support rod 73 rotate relative to the first base 71/the second base 72 to realize the position adjustment of the support rod 73. Moreover, when the ball head end 73b partially contacts the inner wall of the spherical groove 73a, it can play a supporting role under the interaction force. At this stage, the positional relationship between the support rod 73, the first base 71, and the second base 72 remains unchanged.

The above description is only a preferred embodiment of the present disclosure and does not limit the present disclosure in any way. Any simple modification, change and equivalent structural change made to the above embodiment according to the technical essence of the disclosure shall still fall within the protection scope of the technical solution of the present disclosure.

What is claimed is:

1. A vehicle covering system, characterized in that it comprises:
A carriage frame mechanism is configured to be mounted on a truck carriage, wherein the carriage frame mechanism encloses a large open cavity;
A cover system is mounted on a carriage frame mechanism and is used to cover an open large cavity; the cover system comprises: one or more movable cover frame mechanisms, and a cover plate mounted in each cover frame mechanism, the cover frame mechanism divides the large cavity into one or more small cavities; the cover system has at least an unfolded position state and a stowed position state relative to the carriage frame mechanism;
A latch mechanism is arranged on the cover frame mechanism, and the cover frame mechanism is releasably engaged with the second longitudinal frame through the latch mechanism, and the latch mechanism has at least an unlocked state and a locked state; the latch mechanism comprises:
a latch base plate secured to the cover frame mechanism;
A first latch cover body is assembled on the latch bottom plate, and a latch cavity is formed between the first latch cover body and the latch bottom plate;
A lock tongue is movably disposed in the latch cavity, one end of the lock tongue is a locking end, and the other end is a transmission end, and the lock tongue has a lock tongue inner cavity, and the lock tongue inner cavity has an opening;
A pull cord connected to the transmission end of the lock body, the pull cord being controlled by the user;
The limiting part is located above the latch bottom plate, and the limiting part extends into the inner cavity of the lock tongue through the opening;
The spring is arranged in the inner cavity of the lock tongue, one end of the spring contacts the limiting part, and the other end contacts the inner wall of the inner cavity of the lock tongue.

2. The vehicle covering system according to claim 1, characterized in that: when the latch mechanism is in an unlocked state, the cover frame mechanism can move relative to the vehicle frame mechanism; when the latch mechanism is in a locked state, the cover frame mechanism is stationary relative to the vehicle frame mechanism;
The user pulls the pull rope backward to control the lock tongue to move backward, and the latch mechanism switches to the unlocked state, so that the locking end and the second longitudinal frame are staggered in the vertical position, and the cover frame mechanism can move relative to the carriage frame mechanism;
When the user releases the pull cord, the spring acts on the lock tongue, causing the lock tongue to move forward so that the locking end overlaps with the second longitudinal frame in the vertical position, and the latch mechanism switches to the locked state, and the cover frame mechanism cannot move relative to the car frame mechanism.

3. The vehicle covering system according to claim 1 is characterized in that a connecting plate is attached to the car frame mechanism, the connecting plate is covered on the inner wall of the car frame mechanism, and the connecting plate is located between the car frame mechanism and the locking tongue.

4. The vehicle covering system according to claim 3, characterized in that: the connecting plate comprises a vertical portion, a first transverse portion bent outward from one end of the vertical portion, and a second transverse portion bent inward from the other end of the vertical portion;
The inner surface of the carriage frame mechanism has a first toothed side wall, and the outer surface of the vertical portion has a second toothed side wall, and the first toothed side wall and the second toothed side wall are meshed with each other so that the connecting plate is attached to the carriage frame mechanism.

5. The vehicle covering system according to claim 4, characterized in that: the first transverse portion has a first accommodating groove, and the lower end of the first longitudinal frame is inserted into the first accommodating groove;
The second transverse portion has a second accommodating groove, and the inner side of the first longitudinal frame has a positioning block, which is inserted into the second accommodating groove.

6. The vehicle covering system according to claim 4, wherein the vertical portion is fixed to the second longitudinal frame by a first fastener.

7. The vehicle covering system according to claim 1, wherein the latch mechanism further comprises:
A backing plate is arranged in the latch cavity, and the limiting portion is formed on the backing plate;
a second fastener that integrally connects the first latch cover, the backing plate, and the latch base;
A draw cord protection housing is attached to the draw cord.

8. The vehicle covering system according to claim 1, characterized in that: the latch mechanism further comprises a second latch cover body, one end of the second latch cover body abuts against the first latch cover body, and the other end of the second latch cover body is fixed to the cover plate by a third fastener;
The second latch cover covers the connection between the transmission end and the pull rope;
The second latch cover body has a curved section, and the curved section gradually approaches the cover plate from a side close to the first latch cover body toward a side away from the first latch cover body.

9. The vehicle covering system according to claim 1, characterized in that the vehicle covering system further comprises a sealing mechanism, wherein the sealing mechanism comprises:
A longitudinal sealing strip, the longitudinal sealing strip being mounted on the carriage frame mechanism, the longitudinal sealing strip having a first longitudinal side portion, the first longitudinal side portion being inclined downward from the inside to the outside;
A first transverse sealing strip, wherein there is a movable gap between adjacent cover plates, and the first transverse sealing strip is laid between adjacent cover plates so that the first transverse sealing strip blocks the movable gap;
The longitudinal sealing strip and the first transverse sealing strip are interlaced with each other and form an overlapping sealing area.

10. The vehicle covering system according to claim 9, characterized in that: the vehicle frame mechanism comprises:
A first transverse frame is disposed on the front edge of the freight car body;
A second transverse frame is disposed on the rear edge of the freight car body;
A first longitudinal frame is arranged on the left and right edges of the truck compartment, and the first longitudinal frame is located between the first transverse frame and the second transverse frame, and the longitudinal sealing strip is arranged on the first longitudinal frame;
The corner connecting member is fixed to the first transverse frame/the second transverse frame, and the corner connecting member rests on the first longitudinal frame.

11. The vehicle covering system according to claim 10, characterized in that: the covering frame mechanism comprises:
One or more third transverse frames are arranged between the left and right two first longitudinal frames;
A plurality of second longitudinal frames are arranged on the upper end of the first longitudinal frame, and the second longitudinal frames are spliced between two adjacent third transverse frames.

12. The vehicle covering system according to claim 11, characterized in that the third transverse frame and the second longitudinal frame both have a second mounting groove, and the edge of the cover plate is embedded in the second mounting groove, so that the cover plate is matched on the cover frame mechanism.

13. The vehicle covering system according to claim 11, characterized in that: the longitudinal sealing strip is located between the first longitudinal frame and the second longitudinal frame, and the second longitudinal frame presses the longitudinal sealing strip against the second longitudinal frame under the action of gravity;
The movable gap is formed between two adjacent third transverse frames, and the first transverse sealing strip is assembled on the third transverse frame to seal the movable gap.

14. The vehicle covering system according to claim 13, characterized in that: the lower end of the first transverse sealing strip has a strip-shaped mounting portion, the third transverse frame is provided with a first mounting groove, the strip-shaped mounting portion is inserted into the first mounting groove, so that the first transverse sealing strip is engaged with the third transverse frame;
longitudinal side edge of the first transverse sealing strip is bent downward to form a sealing crimping portion, and the sealing crimping portion is tightly fitted on the upper end surfaces of the third transverse frame and the second longitudinal frame.

15. The vehicle covering system according to claim 13, characterized in that: the longitudinal sealing strip has a second longitudinal side portion, the second longitudinal side portion is inclined downward from the inside to the outside, and the second longitudinal side portion is located on the inner side of the first longitudinal side portion;
Under the action of gravity, the second longitudinal frame presses the second longitudinal side edge portion of the longitudinal sealing strip against the second longitudinal frame;
A raised portion is provided at the upper end of the first longitudinal frame, and the raised portion is tightly fitted with the longitudinal sealing strip.

16. The vehicle covering system according to claim 13, characterized in that: the sealing mechanism further comprises a supplementary sealing strip, a frame gap is formed between two adjacent second longitudinal frames, and the supplementary sealing strip is inserted into the frame gap;
longitudinal side edges of the supplementary sealing strip are in contact with the two second longitudinal frames respectively, the upper end surface of the supplementary sealing strip is in contact with the first transverse sealing strip, and the lower end surface of the supplementary sealing strip is in contact with the first longitudinal frame.

17. The vehicle covering system according to claim 10, characterized in that: the sealing mechanism further comprises:
A second transverse sealing strip is arranged below the first transverse frame, the second transverse sealing strip comprises a first straight sealing portion, a circular sealing portion and a first transverse side portion, the upper end surface of the first straight sealing portion contacts the first transverse frame, the lower end of the circular sealing portion contacts the truck compartment, and the first transverse side portion is inclined downward from the rear to the front;
The third transverse sealing strip is arranged below the second transverse frame. The third transverse sealing strip includes a second straight sealing portion, a second transverse side portion and a third transverse side portion. The upper end surface of the second straight sealing portion contacts the second transverse frame, the lower ends of the second transverse side portion and the third transverse side portion contact the truck compartment, the second transverse side portion and the third transverse side portion are inclined downward from back to front, the size of the third transverse side portion is larger than the size of the second transverse side portion, and the third transverse side portion is located in front of the second transverse side portion.

18. The vehicle covering system according to claim 10 is characterized in that: the second longitudinal frame has a positioning groove at one end close to the third transverse frame, and the end of the third transverse frame is inserted into the positioning groove, so that the third transverse frame and the second longitudinal frame are surrounded by each other to form the small cavity.

19. The vehicle covering system according to claim 1, characterized in that: the truck trunk system further comprises a supporting mechanism, the supporting mechanism can act on the covering system so that the covering system has a standing position relative to the vehicle frame mechanism;
The supporting mechanism includes:
A first base is arranged on the carriage frame mechanism;
A second base is configured on any one or more cover plates;
A support rod having a first end and a second end, wherein the first end is hinged to the first base and the second end is detachably connected to the second base;
The hook is arranged on the carriage frame mechanism and has a hanging groove, and the support rod can be inserted into the hanging groove or detached from the hanging groove.

20. The vehicle covering system according to claim 19 is characterized in that: the first end and the second end both have a spherical groove, the first base and the second base both have a ball head end, and the ball head end can be inserted into the spherical groove or detached from the spherical groove.
